(19) United States
(12) Patent Application Publication
(10) Pub. No.: US 2018/0111282 A1
(43) Pub. Date: Apr. 26, 2018

(54) CUT DATA GENERATING APPARATUS, CUT DATA GENERATING METHOD, AND NON-TRANSITORY RECORDING MEDIUM STORING CUT DATA GENERATING PROGRAM

(71) Applicant: BROTHER KOGYO KABUSHIKI KAISHA, Nagoya (JP)

(72) Inventors: Yoko YAMANASHI, Nagoya-shi (JP); Kiyokazu SEKINE, Nagoya-shi (JP)

(21) Appl. No.: 15/848,957

(22) Filed: Dec. 20, 2017

Related U.S. Application Data
(63) Continuation of application No. PCT/JP2016/066160, filed on Jun. 1, 2016.

(30) Foreign Application Priority Data
Jun. 24, 2015 (JP) 2015-126549

(51) Int. Cl. B26D 5/00; G05B 19/408; B23B 27/16; G05B 19/18; G06F 3/03

(52) U.S. Cl. CPC B26D 5/005; G05B 19/4083; B23B 27/1685; G05B 2219/49; G06F 3/03; G05B 19/4086; G05B 19/182

(57) ABSTRACT

A cut data generating apparatus for generating cut data for allowing a cutting apparatus including a cutting mechanism to cut a pattern out of a target workpiece includes a controller, the controller being configured to control the cut data generating apparatus to: identify an outline of the pattern; form a first cutting line that has a jagged shape swinging with a predetermined swinging amount in a direction intersecting with the outline, along the outline; and generate the cut data for cutting along the first cutting line.

### CROSS-REFERENCE TO RELATED APPLICATION

This application is a continuation application of International Application No. PCT/JP2016/066160, filed on Jun. 1, 2016, which claims priority from Japanese Patent Application No. 2015-126549, filed on Jun. 24, 2015. The disclosure of the foregoing application is hereby incorporated by reference in its entirety.

### FIELD

The present disclosure relates a cut data generating apparatus, a cut data generating method, and a non-transitory recording medium storing a cut data generating program that generate cut data for allowing a cutting apparatus including a cutting mechanism to cut a pattern having a predetermined shape out of a target workpiece.

### BACKGROUND

Conventionally, a cutting apparatus has been known that cuts, by a cutting mechanism, a predetermined shape out of a sheet-shaped target workpiece, such as paper or cloth, based on cut data.

### SUMMARY

Such a type of conventional cut data is for achieving cutting so that cutting lines can include straight lines or smooth curves to acquire an outline that clearly defines a pattern. However, certain users may prefer cutting having a hand-torn feature in cases where fur is expressed in a pattern of an animal and where blurred pieces of scenery, such as bushes and clouds, are expressed, for example. Accordingly, there is a demand for generating cut data that allows cutting having a hand-torn feature.

The present disclosure has been made in view of the above described situation, and has an object to provide a cut data generating apparatus, a cut data generating method, and a non-transitory recording medium storing a cut data generating program that can generate cut data that is for cutting a pattern having a predetermined shape out of a target workpiece and is capable of achieving cutting having a hand-torn feature.

To achieve the object described above, a cut data generating apparatus according to the present disclosure that generates cut data for allowing a cutting apparatus including a cutting mechanism to cut a pattern out of a target workpiece, includes a controller, the controller being configured to control the cut data generating apparatus to: identify an outline of the pattern; form a first cutting line that has a jagged shape swinging with a predetermined swinging amount in a direction intersecting with the outline, along the outline; and generate the cut data for cutting along the first cutting line.

The “predetermined swinging amount” in this specification is not limited to a certain swinging amount identified by a certain value, but encompasses multiple swinging amounts identified by respective values different from each other.

This summary is not intended to identify critical or essential features of the disclosure, but instead merely summarizes certain features and variations thereof. Other details and features will be described in the sections that follow.

### BRIEF DESCRIPTION OF THE DRAWINGS

Aspects of the disclosure are illustrated by way of example, and not by limitation, in the accompanying figures in which like reference characters may indicate similar elements.

FIG. 1 is a perspective view illustrating a first embodiment of the present disclosure and schematically illustrating an appearance of a cutting apparatus serving as a cut data generating apparatus;

FIG. 2 is a block diagram schematically illustrating an electrical configuration of the cutting apparatus;

FIG. 3 is a flowchart illustrating processing procedures of a process of generating hand-torn cut data executed by a controller;

FIG. 4A is a diagram for illustrating a method of generating a first cutting line (Stage 1);

FIG. 4B is a diagram for illustrating the method of generating a first cutting line (Stage 2);

FIG. 4C is a diagram for illustrating the method of generating a first cutting line (Stage 3);

FIG. 4D is a diagram for illustrating the method of generating a first cutting line (Stage 4);

FIG. 5 is a diagram illustrating a distance determining method;

FIG. 6 is a diagram illustrating a relationship between the size of a pattern and a threshold that is a predetermined distance;

FIG. 7A is a diagram illustrating an example of the pattern;

FIG. 7B is a diagram illustrating a first cutting line;

FIG. 8A is a diagram illustrating an example of another pattern and illustrating a case where the first cutting line is partially in proximity (or intersects) (Stage 1);

FIG. 8B is a diagram illustrating the example of the other pattern and illustrating the case where the first cutting line is partially in proximity (or intersects) (Stage 2);

FIG. 8C is a diagram illustrating the example of the other pattern and illustrating the case where the first cutting line is partially in proximity (or intersects) (Stage 3);

FIG. 8D is a diagram, illustrating the example of the other pattern and illustrating the case where the first cutting line is partially in proximity (or intersects) (Stage 4);

FIG. 9A is a diagram illustrating an example of yet another pattern and illustrating a case where the first cutting line is partially in proximity (Stage 1);

FIG. 9B is a diagram, illustrating the example of the other pattern and illustrating the case where the first cutting line is partially in proximity (Stage 2);

FIG. 9C is a diagram illustrating the example of the other pattern and illustrating the case where the first cutting line is partially in proximity (Stage 3);

FIG. 9D is a diagram illustrating the example of the other pattern and illustrating the case where the first cutting line is partially in proximity (Stage 4);

FIG. 10 is a flowchart illustrating a second embodiment and illustrating processing procedures of a process of generating hand-torn cut data executed by a controller;

FIG. 11A is a diagram for illustrating a method of generating a first cutting line (Stage 1);

FIG. 11B is a diagram for illustrating a method of generating the first cutting line (Stage 2);

FIG. 11C is a diagram for illustrating a method of generating the first cutting line (Stage 3);

FIG. 12 is a flowchart illustrating a third embodiment and illustrating processing procedures of a process of generating hand-torn cut data executed by a controller;

FIG. 13A is a diagram illustrating a fourth embodiment and illustrating a pattern in a case of partial specification;

FIG. 13B is a diagram illustrating a first cutting line;

FIG. 14 is a diagram illustrating a fifth embodiment and illustrating appearances of a cut data generating apparatus and a cutting apparatus; and

FIG. 15 is a block diagram schematically illustrating electrical configurations of the cut data generating apparatus and the cutting apparatus.

### DETAILED DESCRIPTION

For a more complete understanding of the present disclosure, needs satisfied thereby, and the objects, features, and advantages thereof, reference now is made to the following descriptions taken in connection with the accompanying drawings. Hereinafter, illustrative embodiments will be described with reference to the accompanying drawings.

### (1) First Embodiment

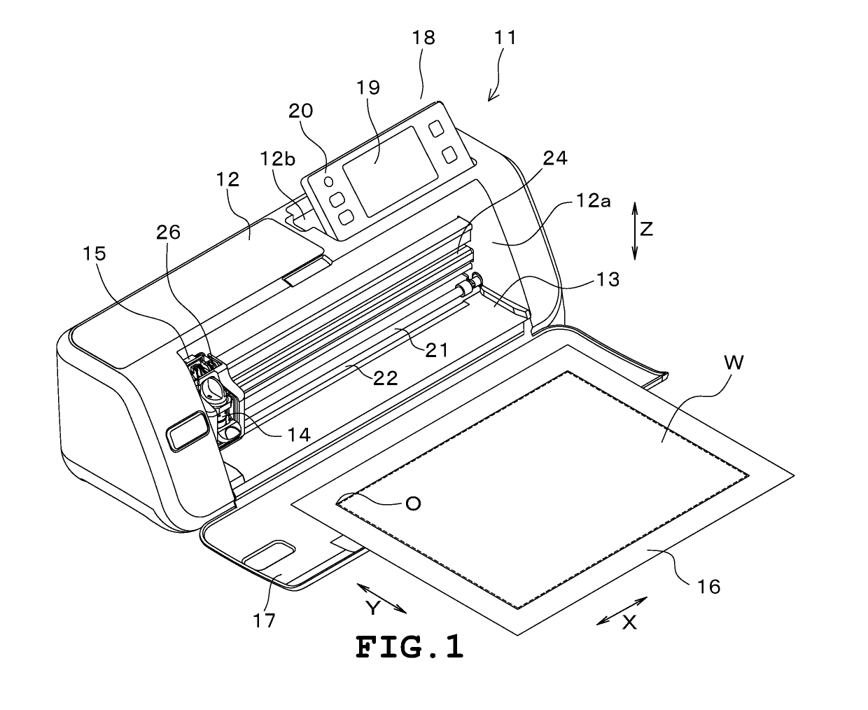

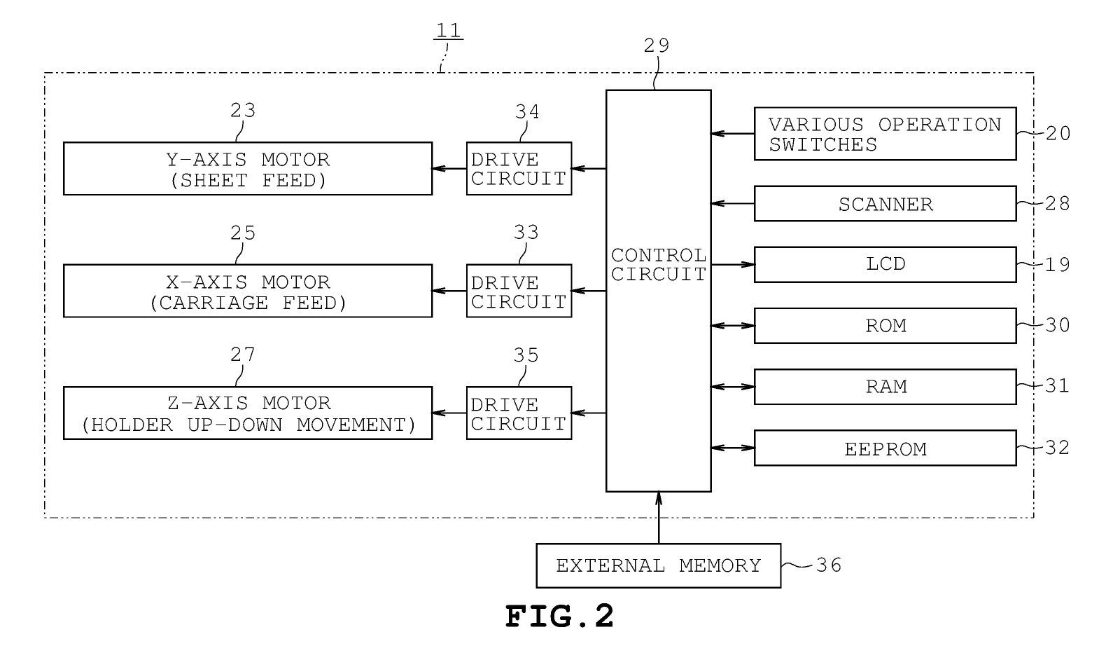

Hereinafter, a first embodiment that is a specific implementation of the present disclosure is described with reference to FIGS. 1 to 9. In the first embodiment, a cutting apparatus also serves as a cut data generating apparatus. FIG. 1 illustrates an appearance configuration of the cutting apparatus 11 serving as the cut data generating apparatus according to this embodiment. FIG. 2 schematically illustrates the electrical configuration of the cutting apparatus 11. The cutting apparatus 11 is an apparatus that automatically cuts a target workpiece W, such as paper or a sheet, according to cut data.

As illustrated in FIG. 1, the cutting apparatus 11 includes a body cover 12, a platen 13 disposed in the body cover 12, and a cut head 15 that includes a cutter cartridge 14. The cutting apparatus 11 includes a holding member 16 for holding the target workpiece W serving as a cutting target workpiece. The holding member 16 includes a base portion that has an overall shape of a rectangular thin plate, and an adhesive layer provided on an upper surface of the base portion. The adhesive layer holds the target workpiece W in a peelable manner.

The body cover 12 has a laterally elongated rectangular box shape with its front surface being slightly obliquely inclined. A front surface opening 12a that opens in a laterally elongated manner is formed at the front surface portion of this cover. A lower side portion of the front surface of the body cover 12 is provided with a front cover 17 for opening and closing the front surface opening 12a, in a turnable manner. The holding member 16 is inserted from the front into the cutting apparatus 11 in a state where the front cover 17 is opened, and is set on the upper surface of the platen 13. The upper surface of the platen 13 forms a horizontal plane. The holding member 16 is mounted on this surface, and is fed in the forward and rearward direction (Y direction).

An operation panel 18 is provided at a right portion on the upper surface of the body cover 12. The operation panel 18 includes a liquid crystal display (LCD) 19, and various operation switches 20 for allowing a user to perform various operations of designation, selection or input. The various operation switches 20 include a touch panel provided on the surface of a display 19.

A feed mechanism that feeds the holding member 16 on the upper surface of the platen 13 in the forward and rearward direction (Y direction) is provided in the body cover 12. Furthermore, a cutter transfer mechanism that transfers the cut head 15 in the left and right direction (X direction) is provided. Here, the directions in this embodiment are defined. The feed direction of the holding member 16 by the feed mechanism is defined as the forward and rearward direction (Y direction). The transfer direction of the cut head 15 by the cutter transfer mechanism is defined as the left and right direction (X direction). The direction orthogonal to the forward and rearward direction and the left and right direction is defined as the up and down direction (Z direction).

The feed mechanism is described. A pinch roller 21 and a drive roller 22 that each extend in the left and right direction are provided to be arranged on an upper position and a lower position, respectively, in the body cover 12. The holding member 16 is fed in the forward and rearward direction with left and right edge portions being clamped between the pinch roller 21 and the drive roller 22. Although not illustrated in detail, a Y-axis motor 23 (illustrated only in FIG. 2), and a gear mechanism that transmits the rotation of the Y-axis motor 23 to the drive roller 22 are provided at a right side portion in the body cover 12. Accordingly, the drive roller 22 is rotated by the Y-axis motor 23, thereby allowing the feed mechanism to feed the holding member 16 in the forward and rearward direction.

Next, the cutter transfer mechanism is described. A guide rail 24 that is disposed rear and above the pinch roller 21 and extends in the left and right direction is arranged in the body cover 12. The cut head 15 is supported by the guide rail 24 in a manner movable in the left and right direction. Although not illustrated in detail, an X-axis motor 25 (illustrated only in FIG. 2), and a drive pulley rotated by the X-axis motor 25 are provided at a left side portion in the body cover 12.

On the other hand, although not illustrated, a follower pulley is provided at a right side portion in the body cover 12. An endless timing belt extends in the left and right direction between the drive pulley and the follower pulley, and is horizontally wound around these pulleys. An intermediate portion of the timing belt is coupled to the cut head 15. Accordingly, the cutter transfer mechanism transfers the cut head 15 in the left and right direction through the timing belt by the rotation of the X-axis motor 25.

The cut head 15 includes a cartridge holder 26, and an up-down drive mechanism that drives the cartridge holder 26. The cartridge holder 26 detachably holds the cutter cartridge 14. Although not illustrated, the cutter cartridge 14 includes a cutter along the central axis of a cylindrical case that extends in the vertical direction of this case. At a lower end of the cutter, a blade is formed. The cutter cartridge 14 holds the cutter at a position allowing the blade to protrude slightly from the lower end portion of the case.

The up-down drive mechanism includes a Z-axis motor 27 (illustrated only in FIG. 2) and the like, and is configured to transfer the cutter cartridge 14 between a lowered position at which the cutting target workpiece is cut by the blade of the cutter and a lifted position at which the blade of the cutter is separated from the cutting target workpiece by a predetermined distance. At the normal time, that is a time at which no cutting operation is performed, the cutter cartridge 14 is positioned at the lifted position. At the time of cutting operation, this cartridge is moved to the lowered position by the up-down drive mechanism.

The cutting mechanism is configured as described above. At the time of cutting operation, the blade of the cutter is in a state of penetrating the target workpiece W, which is the cutting target workpiece held by the holding member 16, in the thickness-wise direction. In this state, the feed mechanism moves the target workpiece W held by the holding member 16 in the forward and rearward direction, and the cutter transfer mechanism moves the cut head 15, i.e., the cutter, in the left and right direction, thereby applying the cutting operation to the target workpiece W. As illustrated in FIG. 1, the cutting apparatus 11 employs an X-Y coordinate system with the left rear corner of the adhesive portion of the holding member 16 being an origin O, and controls the cutting operation based on cut data indicated by the X-Y coordinate system.

As illustrated in FIG. 2, the cutting apparatus 11 of this embodiment includes a scanner 28 that reads a pattern on the surface of the target workpiece W held by the holding member 16. The scanner 28 includes, for example, a contact image sensor (CIS). The scanner 28 is provided to extend in the X direction to have a length substantially equivalent to the width dimension of the holding member 16. The scanner 28 reads the pattern on the surface of the target workpiece W while the feed mechanism feeds the holding member 16 in the rearward direction. Image data thus read by the scanner 28 is used to generate cut data, for example.

As illustrated in FIG. 2, the cutting apparatus 11 includes a control circuit 29 as a control unit. The control circuit 29 is made up mainly of a computer (CPU), and is responsible for the overall control of the cutting apparatus 11. The LCD 19 and the various operation switches 20, and a ROM 30, a RAM 31 and an EEPROM 32 are connected to the control circuit 29. Drive circuits 33, 34 and 35 that drive the X-axis motor 25, the Y-axis motor 23 and the Z-axis motor 27, respectively, are connected to the control circuit 29. Furthermore, an external memory 36, for example an USB memory or the like, is connectable to the control circuit 29.

The ROM 30 stores various control programs, such as a cut control program for controlling the cutting operation, an image reading program that reads image data, a cut data generating program that generates and edits the cut data, and a display control program that controls the display of the LCD 19. The RAM 31 temporarily stores data and programs required for various processes. The EEPROM 32 or the external memory 36 stores outline data pertaining to various patterns, and cut data generated to cut the patterns having predetermined shapes.

The cut data indicates a cut position for cutting the cutting target workpiece W, and is made up of a set of data items having coordinate values that indicate cut positions in the XY coordinate system. The control circuit 29 executes the cut control program, to thereby control the X-axis motor 25, the Y-axis motor 23 and the Z-axis motor 27 through the respective drive circuits 33, 34 and 35 according to the cut data, and to automatically execute the cutting operation for the target workpiece W held by the holding member 16.

In this embodiment, the control circuit 29 executes the cut data generating program to execute each process as the cut data generating apparatus that generates the cut data. The cut data generating program is not limited to a program preliminarily stored in the ROM 30. Alternatively, the cut data generating program may be configured to be recorded in an external non-transitory recording medium, for example, an optical disk or the like and to be read from the non-transitory recording medium. Furthermore, the program may be a program to be downloaded from the outside via a network.

Typically, for example, the cut data is generated by acquiring outlines that represent a pattern made up of closed diagrams from among multiple patterns stored in the EEPROM 32 or read from the scanner 28 based on data on the pattern selected by the user, and by generating the cut data for cutting along the outline based on the outline data. At this time, in this embodiment, when the control circuit 29 generates the cut data, the user operates the operation switches 20 to thereby allow an instruction for a hand-torn cut data generating process to be issued. Here, the hand-torn cut data is cut data capable of cutting having a hand-torn feature in cases where fur is expressed in a pattern of an animal and where blurred pieces of scenery, such as bushes and clouds, are expressed, for example.

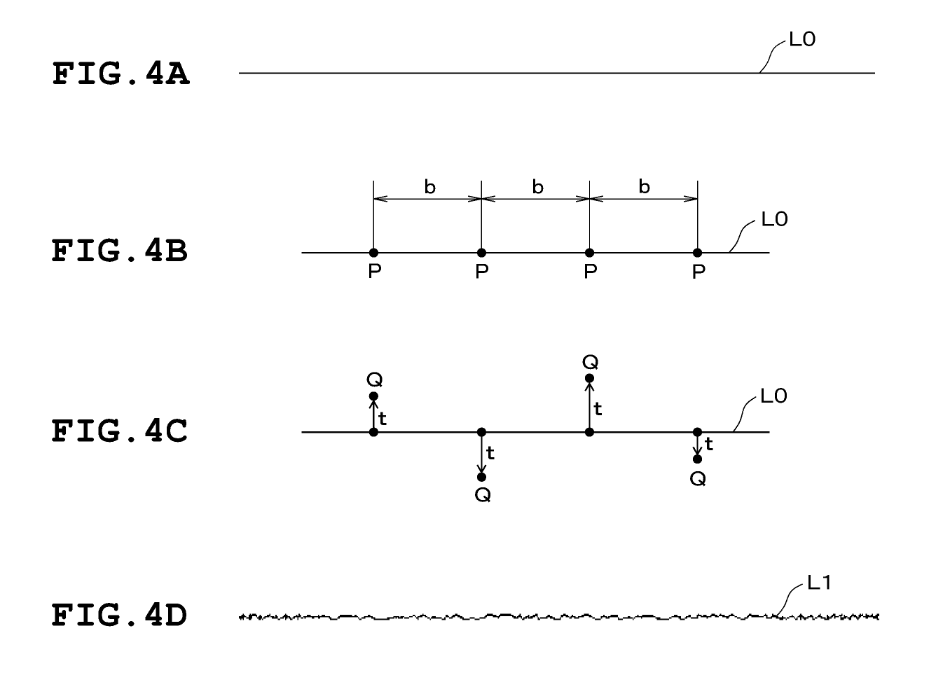

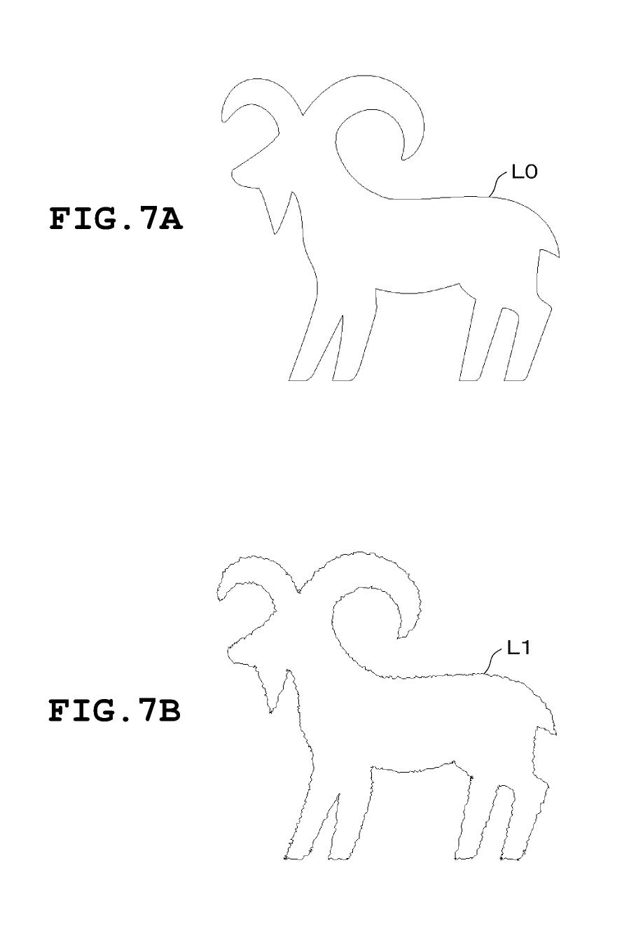

As described in detail later, in this embodiment, the process of generating the hand-torn cut data by the control circuit 29 is performed as follows. That is, first, an outline identifying step of identifying an outline L0 of a pattern (see FIGS. 4A to 4D, 7A and 7B, and the like) is executed. Next, a first cutting line generating step is executed that generates a first cutting line L1 that has a jagged shape swinging with a random swinging amount in a direction of intersecting with the outline L0 along the outline L0. A cut data generating step that generates the cut data for cutting along the first cutting line L1 is executed. Consequently, the control circuit 29 functions as an outline identifying unit, a first cutting line forming unit, and a cut data generating unit.

Here, FIGS. 7A and 7B illustrate a pattern of “goat” as an example of the pattern. FIG. 7A illustrates the outline L0. FIG. 7B illustrates the first cutting line L1. As for the pattern of goat, the outline L0 is made up of straight lines and smooth curves, as illustrated in FIG. 7A. The process of generating the hand-torn cut data is performed to allow the first cutting line L1 that represents fur to be acquired, as illustrated in FIG. 7B, and allow the cut data for cutting the target workpiece W along the first cutting line L1 to be generated. In FIG. 7B, a process of achieving a hand-torn feature is applied to the entire outline L0.

In this embodiment, for forming the first cutting line L1, as illustrated in FIG. 4, the control circuit 29 disposes configuration points P at predetermined intervals b on the outline L0, moves the configuration points P in the intersecting direction (e.g. the orthogonal direction) with the outline L0 by random swinging amounts t to determine first configuration points Q, and sequentially connects the first configuration points Q, thereby forming the first cutting line L1. Here, the predetermined interval b is called a resolution. In this embodiment, the user operates the operation switches 20, thereby allowing the resolution (predetermined interval b) and the maximum value tₘₐₓ of the swinging amount t to be set. Consequently, the operation switches 20 function as a setting unit and a maximum swinging amount setting unit.

In this embodiment, after formation of the first cutting line L1, the control circuit 29 judges whether or not there is a portion where the segments of the first cutting line L1 are in proximity, less than a predetermined distance D, or intersect with each other. In this case, more specifically, the distances between the first configuration points Q and the corresponding line segments that constitute the first cutting line L1 are acquired and compared with the predetermined distance D. When the control circuit 29 judges the proximity or intersection at the first cutting line L1, this circuit corrects the proximity or intersecting portion between the segments of the first cutting line L1 to secure a space of the predetermined distance D or more, thereby forming a second cutting line L2. Consequently, the control circuit 29 also has functions as a proximity judgment unit and a second cutting line generating unit.

More specifically, when the control circuit 29 corrects the proximity or intersecting portion between the segments of the first cutting line L1 to secure the space of the predetermined distance D or more, this circuit changes the swinging amounts t of the first configuration points Q for generating the first cutting line L1 (for example, reduces the amounts), thereby correcting the positions of the first configuration points to form the second cutting line L2. Alternatively, the transfer direction of the first configuration points Q for generating the first cutting line L1 is changed, for example, to the opposite side of the outline L0, thereby correcting the positions of the first configuration points Q to form the second cutting line L2. Both the swinging amount and the direction may be configured to be changed. When the second cutting line L2 is formed, the control circuit 29 generates the cut data for cutting along the second cutting line L2.

Furthermore, in this embodiment, as illustrated in FIG. 6, the predetermined distance D, which is the threshold for judging the proximity between the segments of the first cutting line L1, is changed according to the size of the pattern such that the larger the size of the pattern, the longer the predetermined distance D is. More specifically, as exemplified in FIG. 6, the predetermined distance D is set to 2, 4, 6 and 8 mm according to the size of the pattern. In this embodiment, when the control circuit 29 judges the proximity (or intersection) between the segments of the first cutting line L1, this circuit notifies this fact. More specifically, this circuit invokes a preview display on the LCD 19. In this embodiment, the control circuit 29 displays, on the LCD 19, the pattern cut out along the first cutting line L1 when the first cutting line L1 is formed. Consequently, the LCD 19 functions as a notification unit and a display unit.

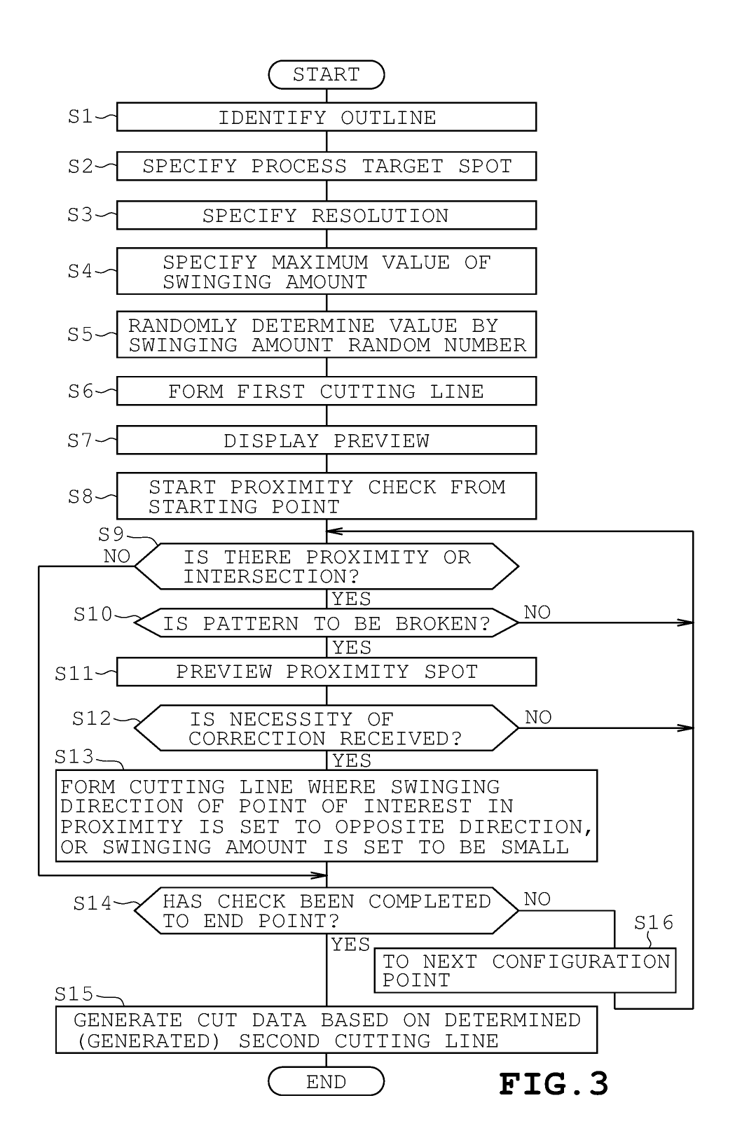

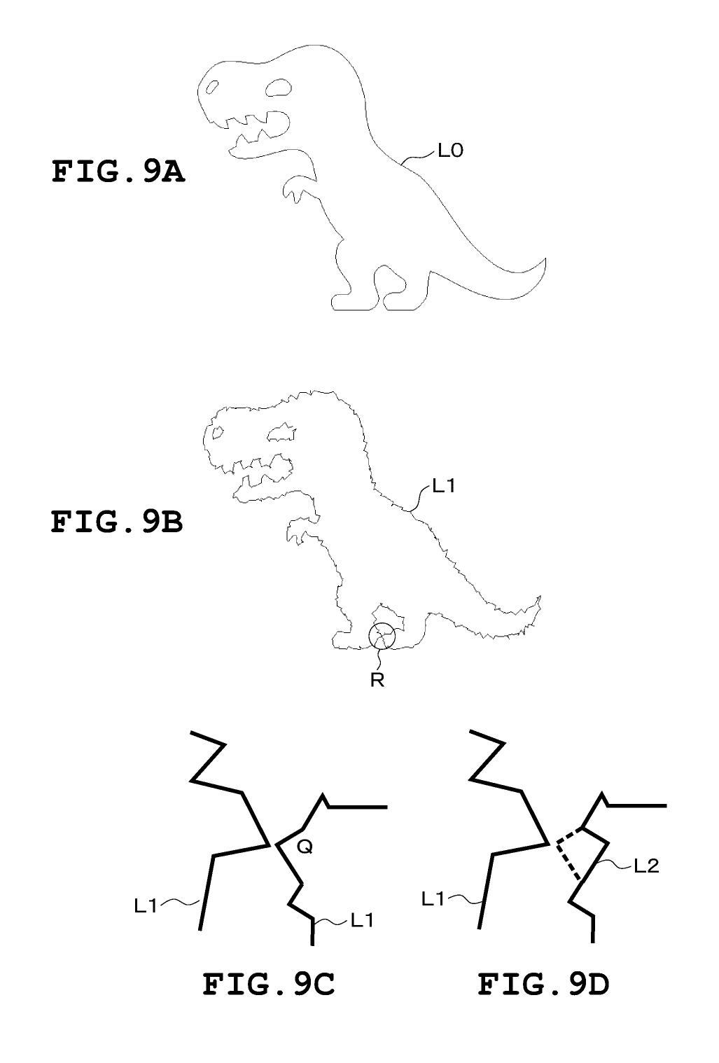

Next, the operation of the configuration described above is described with reference also to FIGS. 3 and 9A to 9D, The flowchart of FIG. 3 illustrates processing procedures for generating hand-torn cut data executed by the control circuit 29 in a case where a pattern is selected by the user's operation through the operation switches 20, and the hand-torn cut data generating process is instructed. That is, first, at step S1, the outline L0 is identified from data on the selected pattern. At step S2, a specification by the user operation for a process target spot on the outline L0 to which the hand-torn cut data generation is performed is received. Here, “entirety” is specified (e.g. set by default).

At step S3, a specification of the resolution (predetermined interval b) by the user operation is received. At step S4, a specification for the maximum, value tₘₐₓ of the swinging amount t by the user operation is received. In this case, the predetermined interval b and the maximum value tₘₐₓ are specified as, for example, 1.0 mm or the like in units of 0.1 mm. A default value may be preset. At step S5, the value of the swinging amount t is set randomly by a random number so as not to exceed the maximum value tₘₐₓ.

In next step S6, a process of forming the first cutting line L1 based on the outline L0 and the determined resolution (predetermined interval b) and the swinging amount t is performed. As exemplified in FIGS. 4A to 4D, for formation of the first cutting line L1, first, configuration points P are disposed by predetermined intervals b on the outline L0 (substantially straight line in this case) illustrated in FIG. 4A, as illustrated in an enlarged state in FIG. 4B, for example. Next, as illustrated in FIG. 4C in an enlarged state, first configuration points Q are determined by swinging the configuration points P in the intersecting (orthogonal) direction with respect to the outline L0 by the swinging amounts t randomly determined for the respective configuration points P. As illustrated in FIG. 4D, the first configuration points Q are sequentially connected by line segments between a starting point, a second point, a third point, . . . , an end point and the starting point, thereby acquiring the first cutting line L1 having a jagged shape along the outline L0.

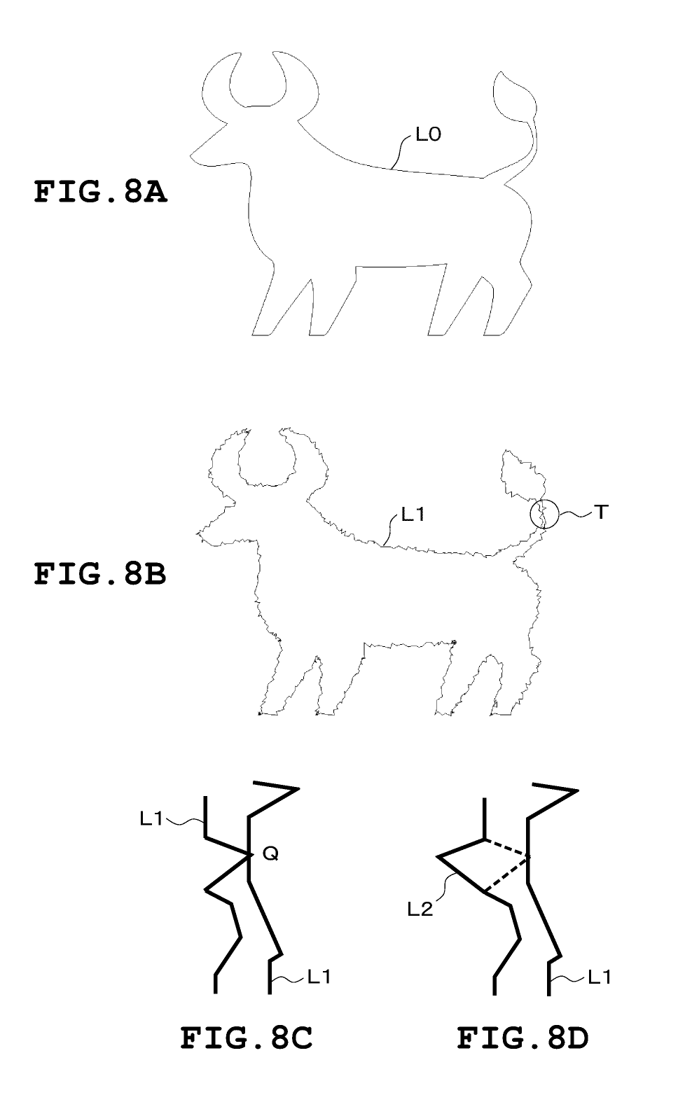

At step S7, the formed first cutting line L1 is allowed to be previewed on the LCD 19. Here, as illustrated in FIGS. 7A and 7B, as for the pattern of “goat”, based on the original outline L0 illustrated in FIG. 7A, the first cutting line L1 illustrated in FIG. 7B is acquired and its image is displayed. FIG. 8B illustrates an example of the first cutting line L1 formed based on an example of the outline L0 of a pattern of “bull” (see FIG. 8A). FIG. 9B illustrates an example of the first cutting line L1 formed based on an example of the outline L0 of a pattern of “dinosaur” (see FIG. 9A). Accordingly, the formed first cutting line L1, that is, an image on a pattern to be cut can be displayed for the user in an easily understandable manner.

Here, a possibility is considered that the formation of the first cutting line L1 by providing the jagged shape as described above may cause the following adverse effect. For example, the first cutting line L1 of the pattern of “bull” illustrated in FIG. 8B has a shape where the segments of the first cutting line L1 intersect with (cut into) each other at a portion T of the tail as illustrated in FIG. 8C. If cut data is formed in this state, the pattern to be cut out is broken at the middle. Also in a case of proximity or contact instead of intersection, there is a possibility that unintended cutting occurs in an analogous manner. The first cutting line L1 of the pattern of “dinosaur” illustrated in FIG. 9B has a shape where the segments of the first cutting line L1 are in proximity to each other at a portion R of a foot as illustrated in FIG. 9C. Formation of cut data in this state causes a possibility that portions of the pattern to be separated from each other after being cut out are left uncut. Also in a case of intersection or contact instead of proximity, analogous uncutting occurs.

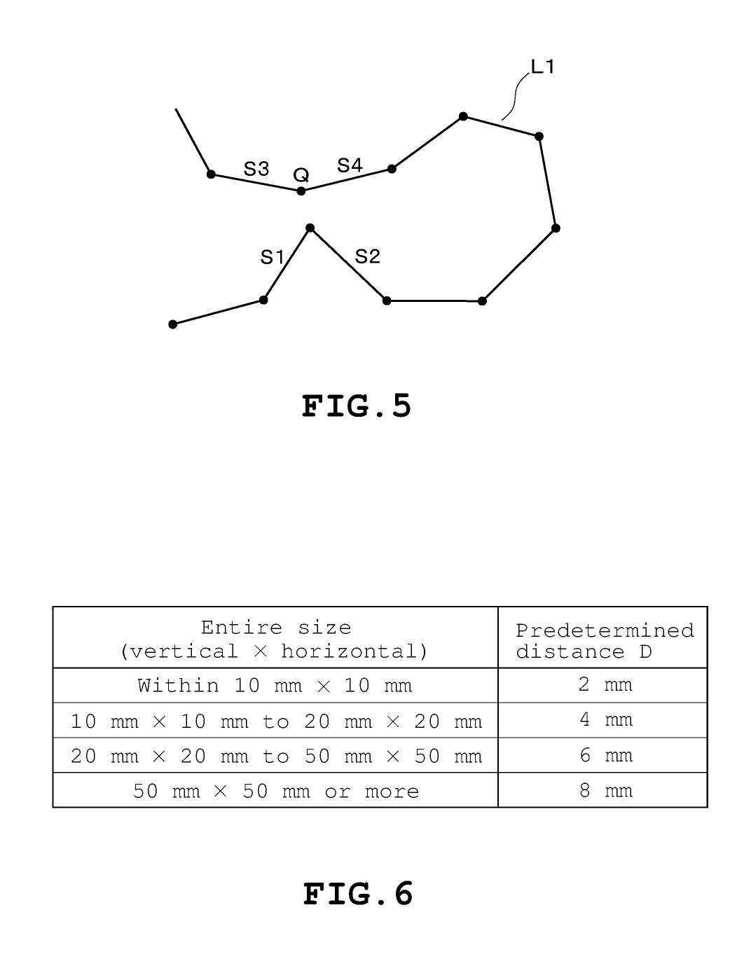

In this embodiment, in processes at and after step S8, it is checked whether or not the segments of the first cutting line L1 are in proximity to or intersect with each other, and a required spot is corrected (formation of the second cutting line L2). At step S8, the proximity or intersection check for the first cutting line L1 is started with the first configuration points Q being adopted as points of interest sequentially from the starting point (to the end point). At step S9, it is judged whether or not the distances between the points of interest and the corresponding line segments are each less than the predetermined distance D. As exemplified in FIG. 5, the distance from the first configuration point Q as the point of interest to the line segments S1 and S2, for example, the shortest distance, is acquired, and it is judged whether or not the distance is less than the predetermined distance D. In this case, line segments S3 and S4 on both the sides (front and rear) of the point of interest (first configuration point Q) are excluded. As illustrated in FIG. 6, the predetermined distance D is set according to the size of the pattern.

When the distance between the point of interest and each line segment is at least the predetermined distance D (No at step S9), it is judged whether or not the check has been completed to the end point at step S14. If not completed (No at step S14), the processing flow proceeds to the next configuration point at step S16, the process flow returns to step S9, and it is judged whether or not the distance to each line segment pertaining to the next point of interest (first configuration point Q) is less than the predetermined distance D. On the contrary, when the distance between the point of interest and each line segment is less than the predetermined distance D (Yes at step S9), it is judged whether there is a possibility that the pattern is broken by proximity or intersection or not in step S10.

As for the judgment whether or not there is a possibility that the pattern is broken, when the segments of the first cutting line L1 are in proximity to each other by a distance less than the predetermined distance D, it is judged whether or not a portion between the segments of the first cutting line L1 is in or out of the pattern. If it is judged that the portion is in the pattern, it can be judged that there is a possibility that the pattern is broken. In the example in FIG. 8C, it is judged that there is a possibility that the pattern is broken. In the case of FIG. 9C, the portion between the segments of the first cutting line L1 is out of the pattern. Consequently, it is judged that there is no possibility that the pattern is broken. When there is no possibility that the pattern is broken (No at step S10), the processing flow returns to step S9, and proximity or intersection check for the next point of interest is performed.

When it is judged that there is a possibility that the pattern is broken (Yes at step S10), the proximity or intersecting spot is allowed to be previewed on the LCD 19 and is thus notified to the user at step S11. The user looks at the view, judges the necessity of correction, and issues a designation of whether correction is performed through the operation switches 20 or not. Upon receipt of the designation of unnecessity of the correction (No at step S12), the processing flow returns to step S9, and proximity or intersection check for the next point of interest is performed. Upon receipt of designation of necessity of the correction (Yes at step S12), the proximity or intersecting portion with the point of interest and the line segment is corrected to be separated by at least the predetermined distance at step S13, and the second cutting line L2 is formed.

The process of correction at step S13 is performed by changing the movement direction of the first configuration point Q in formation of the first cutting line L1 with respect to the first configuration point Q that is the point of interest. Alternatively, the process is performed by changing the swinging amount in formation of the first cutting line L1. In the example in FIGS. 8A, 8B, 8C and 8D, the movement direction of the first configuration point Q is changed to the direction opposite to the original swinging direction as illustrated in FIG. 8D (from the right direction to the left direction in the diagram), thereby forming the second cutting line L2. In the example of FIG. 9C, as it is judged, that there is no possibility that the pattern is broken, correction is not required. However, as illustrated in FIG. 9D, the movement direction of the first configuration point Q may be changed to the direction opposite to the original swinging direction in an analogous manner.

After the second cutting line L2 is thus formed by correcting the first configuration point Q, it is judged whether check has been completed to the end point or not at S14. If not completed (No at step S14), the processing flow proceeds to the next configuration point at step S16 and the processes from step S9 are repeated. After completion of check to the end point (Yes in step S14), the cut data for cutting the target workpiece W along the cutting line is generated at step S15, and the processes are finished. The cutting apparatus 11 performs the cutting operation based on the generated cut data.

As described above, according to this embodiment, execution of the hand-torn cut data generating process identifies the outline of the pattern, forms the first cutting line that has the jagged shape swinging with random swinging amounts in the direction intersecting with the outline along this outline, and generates the cut data for cutting along the first cutting line. Cutting the target workpiece W using the cut data can cut the pattern that has the jagged shape swinging with the random swinging amount, along the outline L0 of the pattern. As a result, an excellent effect capable of generating the cut data that is for cutting the pattern having the predetermined shape out of the target workpiece W and is capable of cutting with the hand-torn feature, is exerted.

In this embodiment, the configuration points P are disposed on the outline L0 at predetermined intervals b, the first configuration points Q are determined by moving the configuration points P with the respective random swinging amounts, and sequentially connects the first configuration points Q with line segments to thereby form the first cutting line L1. Consequently, the jagged shape of the first cutting line L1 having a fineness according to the predetermined interval can be acquired. Here, the predetermined interval, b and the maximum value tₘₐₓ of the swinging amount t are allowed to be set by the user operation. Consequently, the jagged shape of the first cutting line L1 with the fineness and swinging amount that are desired by the user can be acquired.

In particular, according to this embodiment, the proximity with less than the predetermined distance D or intersection between the segments of the first cutting line L1 (between the first configuration point Q and the line segment) is judged, and the second cutting line L2 is formed so that the proximal portion can have a space of at least the predetermined distance D, and the cut data for cutting along the second cutting line L2 is generated. Consequently, the adverse effects due to the jagged shape that include the case where the thin portion of the pattern is broken or the case where the portions that are in proximal but intended to be separated from each other are left uncut, are prevented from occurring.

Upon satisfaction of a condition where it is judged to be in the pattern in a case of proximity less than the predetermined distance D between the segments of the first cutting line L1, the second cutting line L2 is formed. Consequently, the second cutting line L2 is allowed not to be formed unnecessarily. In this embodiment, the second cutting line L2 is formed by changing the movement directions of the first configuration points Q in formation of the first cutting line L1, or the second cutting line L2 is formed by changing the swinging amounts of the first configuration points Q in formation of the first cutting line L1. Consequently, an advantageous effect capable of simply and securely forming the second cutting line L2 can also be exerted.

In the hand-torn cut data generating process (the flowchart of FIG. 3) described above, the step (step S2) of receiving the user specification for the process target spot on the outline L0 of the pattern may be omitted, and the preview of the first cutting line L1 at step S7 and the preview of the proximity or intersecting spot at step S11 can be omitted. Step S10 may be omitted. The process of receiving the user's specification of the necessity of the correction at step S12 may also be omitted, and correction may always be performed.

### (2) Second Embodiment

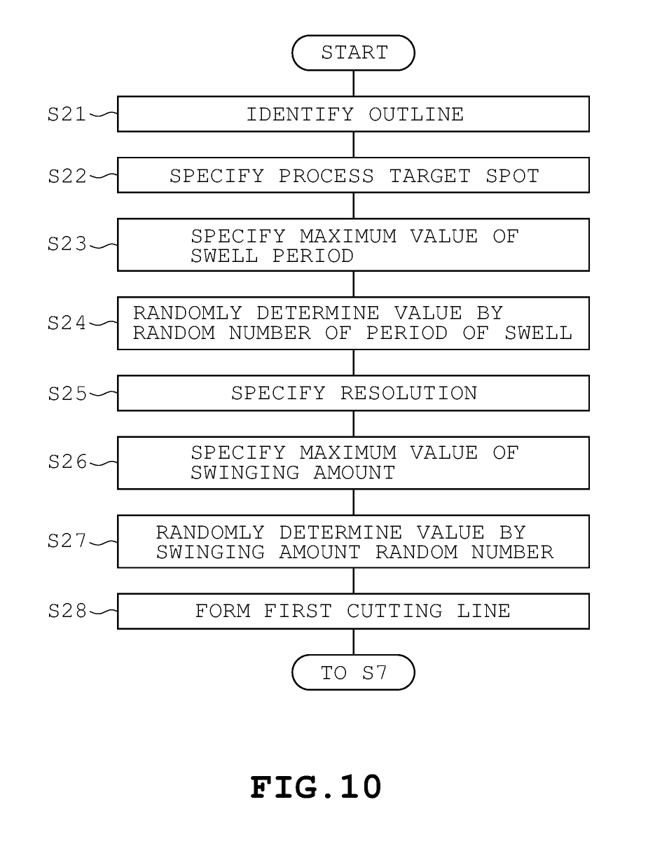

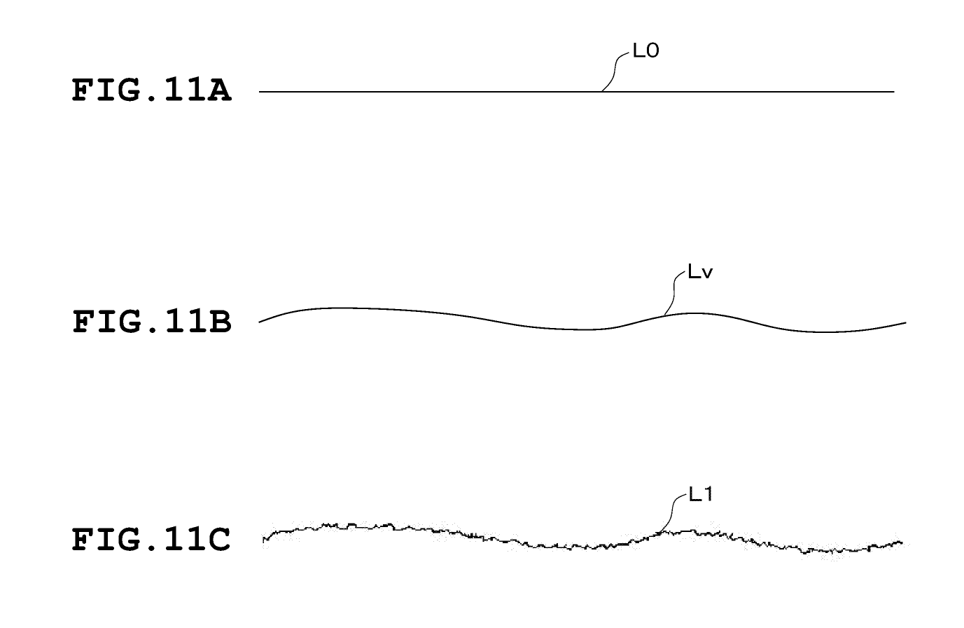

Next, referring to FIGS. 10, 11A, 11B and 11C, a second embodiment is described. In each of embodiments described later, portions common to those in the first embodiment described above are not newly illustrated and described in detail, and are assigned the common symbols. Hereinafter, points different from those in the first embodiment are mainly described.

The second embodiment is different from the first embodiment in the process of generating hand-torn cut data executed by the control circuit 29. As exemplified in FIGS. 11A, 11B and 11C, here, the control circuit 29 determines a virtual outline Lv (see FIG. 11B) acquired by adding periodical wave-shaped swell to the identified outline L0 (see FIG. 11A), adopts the virtual outline Lv as the outline of the pattern, and provides the outline with a jagged shape having random, swinging amounts, thereby forming the first cutting line L1 (see FIG. 11C). Consequently, the control circuit 29 functions as a determination unit.

A flowchart of FIG. 10 illustrates processing procedures for generating hand-torn cut data executed by the control circuit 29, in particular, processing procedures to formation of the first cutting line L1. That is, first, at step S21, the outline L0 is identified from data on the pattern selected by the user. At step S22, a specification for a process target spot on the outline L0 to which the hand-torn cut data is performed is received. At step S23, specification of the maximum value of the period (wavelength) of swell in determination of the virtual outline by a user operation is received. At step S24, based on the maximum value, the period of the swell is randomly determined by random numbers.

At step S25, specification for the resolution (predetermined interval b) by the user operation is received. At step S26, a specification for the maximum value tₘₐₓ of the swinging amount t by the user operation is received. At step S27, the value of the swinging amount t is set randomly by a random number so as not to exceed the maximum value tₘₐₓ. In next step S28, a process of forming the first cutting line L1 is performed for the outline L0 is performed, based on the period of the swell described above, the determined resolution (predetermined interval b), and the swinging amount t. Subsequently, the processes at and after step S7 are executed.

As illustrated in FIG. 11B, first, the process of generating the first cutting line L1 determines the virtual outline Lv acquired by adding the swell to the outline L0 as illustrated in FIG. 11A, Next, as with the first embodiment described above, the virtual outline Lv is adopted as the outline of the pattern, the configuration points P are disposed at predetermined intervals b, the first configuration points Q are determined so that the configuration points P can be swung with determined random swinging amounts t in the intersecting (orthogonal) direction with the outline L0, and the first configuration points Q are sequentially connected with line segments as illustrated in FIG. 11C.

Consequently, also according to the second embodiment, an excellent effect capable of generating the cut data that is for cutting the pattern having the predetermined shape out of the target workpiece W and is capable of cutting with the hand-torn feature, is exerted. Furthermore, after the virtual outline Lv acquired by adding gradual wave-shaped swell to the outline L0 is determined, the virtual outline Lv is adopted as the outline and provided with the jagged shape having random swinging amounts to form the first cutting line L1. Consequently, not only the outline L0 is formed to have the jagged shape in a simple manner but also the shape that has a more complex feature while substantially being along the outline L0 can be cut.

In the hand-torn cut data generating process in the second embodiment described above (the flowchart of FIG. 10), the maximum value of the period (wavelength) of swell in the case of adding the swell to the outline L0 is specified by the user. Alternatively, the period may be determined by default. Alternatively, a configuration may be adopted where the user specifies the wave height (amplitude) or the maximum value of the height of the swell.

### (3) Third Embodiment

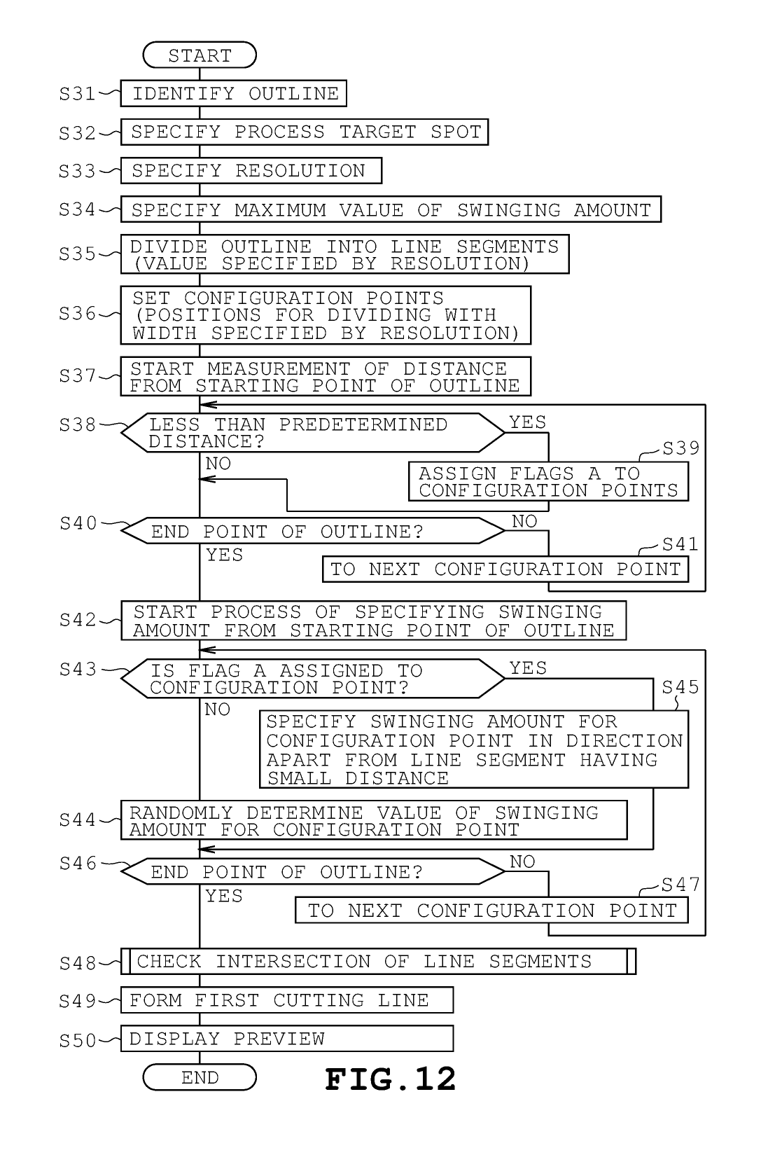

FIG. 12 illustrates a third embodiment of the present disclosure, and is different from the first embodiment described above in the following points. That is, in this embodiment, after the first cutting line L1 is formed, the proximity or intersecting portion is judged and correction is performed. In other words, instead of forming the second cutting line L2, the control circuit 29 extracts the proximity portion in the state of the outline L0 before formation of the first cutting line L1, and forms the first cutting line L1 so that the segments of the first cutting line L1 can be separated by at least the predetermined distance at the proximity portion. Consequently, the control circuit 29 functions as an extraction unit.

A flowchart of FIG. 12 illustrates processing procedures for generating hand-torn cut data executed by the control circuit 29. First, at step S31, the outline L0 is identified. At step S32, a specification of a process target spot on the outline L0 to which generation of the hand-torn cut data is performed is received. At step S33, specification of the resolution (predetermined interval b) by the user operation is received. At step S34, a specification of the maximum value tₘₐₓ of the swinging amount t by the user operation is received. At next step S35, the outline L0 is divided into line segments with the specified predetermined intervals b. At step S36, the configuration points P are set at positions divided by line segments (see FIG. 4B).

At step S37, measurement of the distances between the configuration points P and line segments is started with the point of interest being adopted from the start point sequentially among the configuration points P is started. At step S38, the distance between the point of interest and each of the line segments constituting the outline L0 is acquired, and it is judged whether or not the distance is less than the predetermined distance D. In this case, line segments on both the sides (front and rear) of the point of interest (configuration point P) are excluded. The predetermined distance D can be set according to the size of the pattern, for example. When the distance between the point of interest and each line segment is less than the predetermined distance D (Yes at step S38), a flag A is assigned to the configuration point P at step S39, and the process flow proceeds to step S40.

When the distance between the point of interest and each line segment is at least the predetermined distance D (No at step S38), the process flow proceeds to step S40. At step S40, it is judged whether the check has been completed to the end point or not. If not completed (No at step S40), the next configuration point P is adopted as the point of interest at step S41 and the processes from step S38 are repeated. Accordingly, a narrow portion where the segments of the outline L0 are in proximity to each other by a distance less than the predetermined distance D is extracted, and the flags A are assigned to the configuration points P constituting the narrow portion.

At next step S42, a process is started that specifies the swinging amount t for each of the configuration points P, starting sequentially from the start point. Here, at step S43, it is judged whether the flag A is assigned to the configuration point P or not. If the flag A is not assigned (No at step S43), the value of the swinging amount t for the configuration point P is randomly determined by the random number with the swinging amount t at step S44, and the process flow proceeds to step S46. On the contrary, if the flag A is assigned to the configuration point P (Yes at step S43), the swinging amount t is determined for the configuration point P in the direction apart from the line segment with the small distance at step S45, and the process flow proceeds to step S46. At step S45, the swinging amount t may be configured to be small.

At step S46, it is judged whether or not the process has been completed to the configuration point P that is the end point of the outline L0. If not completed (No at step S46), the processing flow proceeds to the next configuration point P at step S47, and the processes from step S43 are repeated. As described above, when the swinging amounts t are determined for all the configuration points P (Yes at step S46), the intersection between line segments is checked at step S48. The processes are performed in a manner analogous to the processes at step S9 to S14 in the first embodiment described above. Subsequently, at step S49, the first cutting line L1 is formed based on the configuration points P of the outline L0 and the swinging amounts t. The cut data for cutting the target workpiece W along the first cutting line L1 is generated. At step S50, the first cutting line L1 is allowed to be previewed on the LCD 19, and the process flow is finished. The cutting apparatus 11 performs the cutting operation based on the generated cut data.

As with the first embodiment described above, according to the third embodiment, an excellent effect capable of generating the cut data that is for cutting the pattern having the predetermined shape out of the target workpiece W and is capable of cutting with the hand-torn feature, is exerted. The adverse effects due to the jagged shape that include the case where the thin portion of the pattern is broken or the case where the portions that are in proximal but intended to be separated from each other are left uncut are prevented from occurring. Here, the portion in proximity to the outline L0 can be preliminarily extracted before formation of the first cutting line L1, thereby negating the need of the process of correction after formation of the first cutting line L1.
(4) Fourth and Fifth Embodiments and Other Embodiments

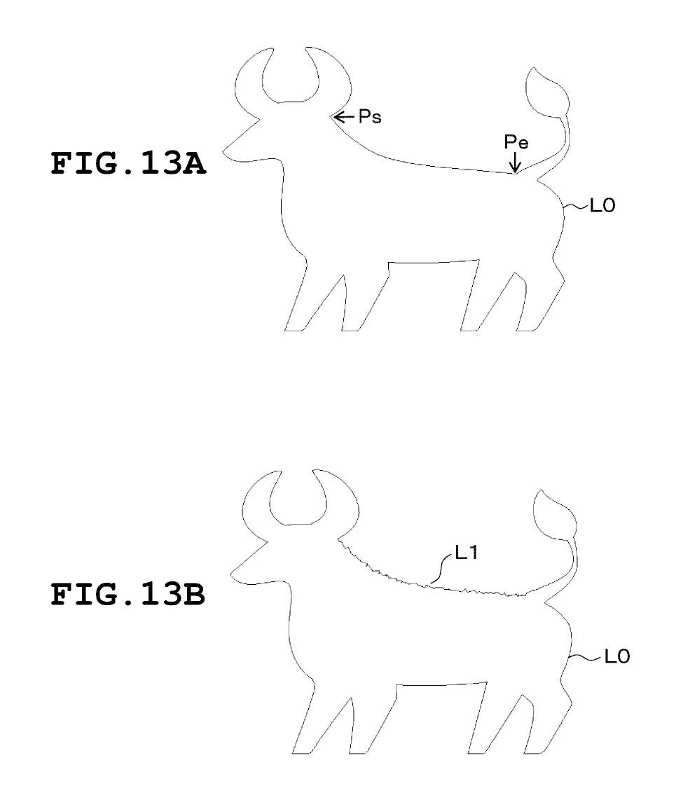

FIG. 13 illustrates a fourth embodiment of the present disclosure. In the fourth embodiment, the user's specification can adopt a part of the pattern as hand-torn cut data, that is, partially specify formation of the first cutting line L1 in the outline L0 (for the remaining part, cut data along the outline L0 is generated). In this case, the user operates the operation switches 20, thereby designating an interval on the outline L0 intended to be adopted as hand-torn cut data, that is a starting point Ps and an end point Pe, on the LCD 19. Consequently, the operation switches 20 function as a partial specification unit.

As illustrated in FIGS. 13A and 13B, a case is exemplified where formation of the first cutting line is specified for a back portion of the pattern (outline L0) of “bull”. Accordingly, as illustrated in FIG. 13B, cut data that expresses fur at the back portion is allowed to be generated. Consequently, the fourth embodiment can generate the cut data that is for cutting the pattern having the predetermined shape out of the target workpiece W and is capable of cutting with the hand-torn feature. In this case, according to the user's preference, the portion that forms the first cutting line L1 in the outline L0 of the pattern is specified, thereby allowing a wide variety of patterns to be cut.

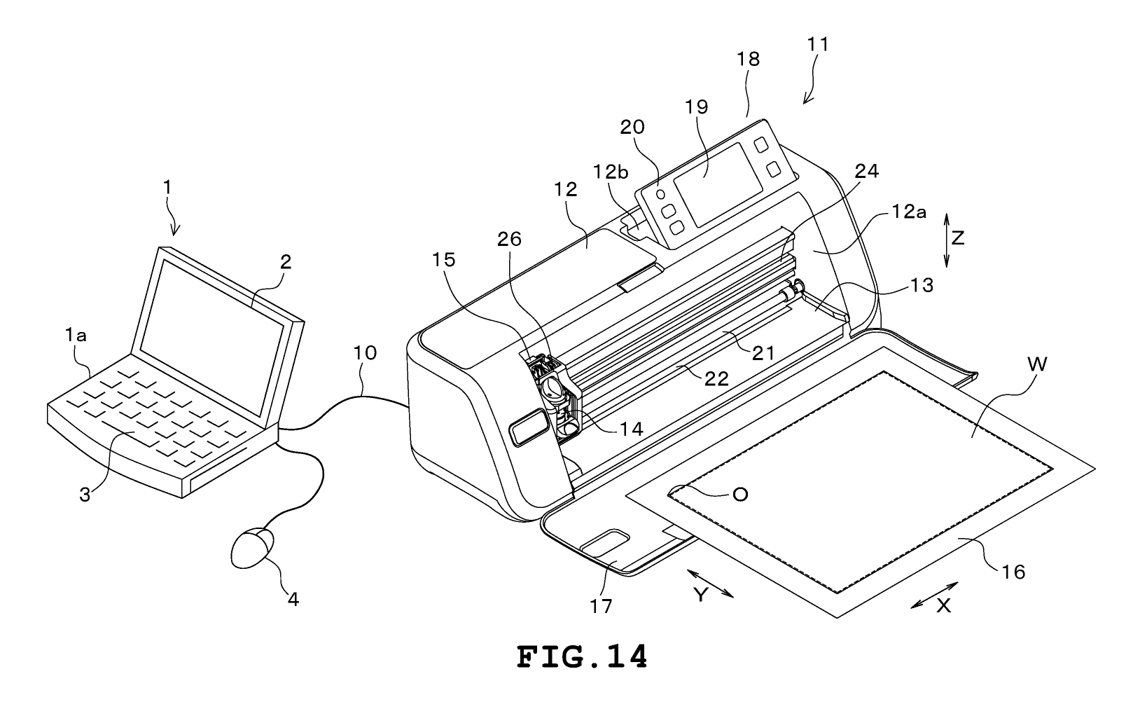

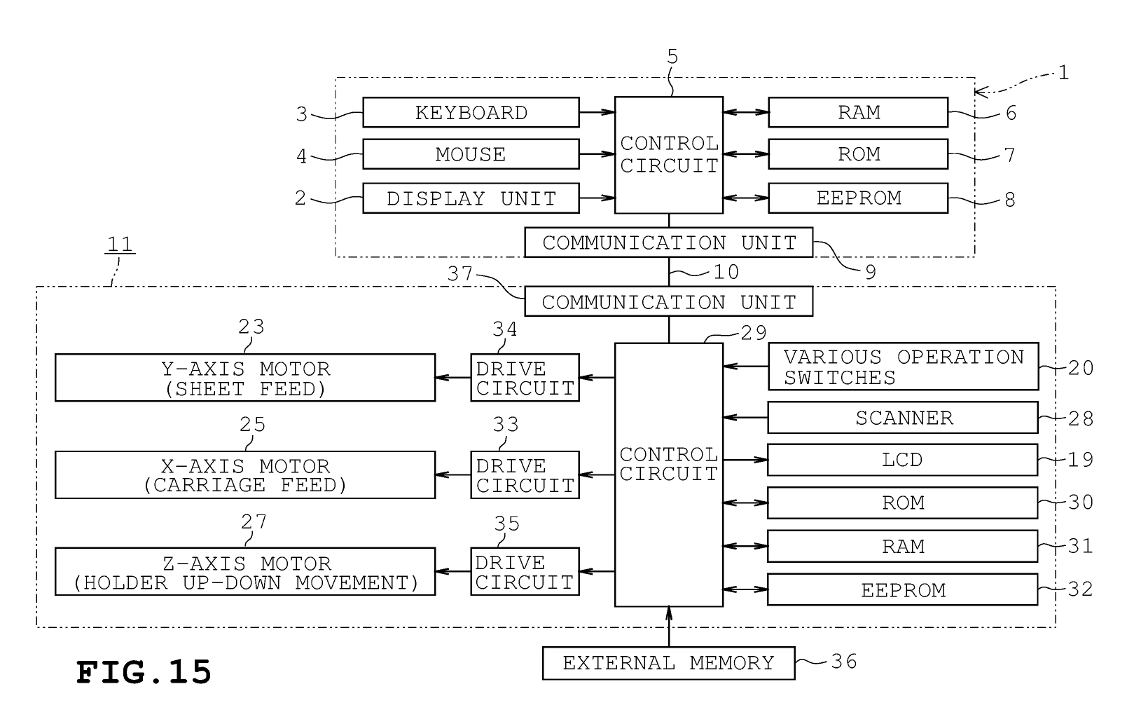

FIGS. 14 and 15 illustrate a fifth embodiment of the present disclosure. FIG. 14 illustrates an appearance configuration of a cut data generating apparatus 1 and a cutting apparatus 11 according to this embodiment. FIG. 15 schematically illustrates electrical configurations of these apparatuses. The cut data generating apparatus 1 according to this embodiment includes a personal computer, for example, and is connected to the cutting apparatus 11 through a communication cable 10. The cutting apparatus 11 is an apparatus that automatically cuts a target workpiece W, such as paper or a sheet, according to cut data.

The cut data generating apparatus 1 includes a personal computer that executes a cut data generating program. As illustrated in FIG. 14, the cut data generating apparatus 1 includes a computer main body 1a, and further includes a display unit (liquid crystal display) 2, a keyboard 3, and a mouse 4 in this body 1a. As illustrated in FIG. 15, the computer main body 1a includes a control circuit 5 configured by mainly including a CPU, and a RAM 6, a ROM 7, an EEPROM 8, a communication unit 9 and the like that are connected to the control circuit 5.

The display unit 2 displays necessary information, such as a message for the user. The keyboard 3 and the mouse 4 are operated by the user. Operation signals thereof are input into the control circuit 5. The RAM 6 temporarily stores the necessary information according to a program, executed by the control circuit 5. The ROM 7 stores a cut data generating program and the like. The EEPROM 8 stores data on various patterns that are generation targets of cut data (outline data, etc.), generated cut data and the like.

The communication unit 9 is configured to communicate data and the like with external apparatuses. In this embodiment, cut data generated by the cut data generating apparatus 1 is transmitted by the communication unit 9 through the communication cable 10 to the communication unit 37 of the cutting apparatus 11. The communication unit 9 of the cut data generating apparatus 1 and the communication unit 37 of the cutting apparatus 11 may be connected to each other via wireless communication. The cut data may be exchanged between the cut data generating apparatus 1 and the cutting apparatus 11 via a detachable external device, such as a USB memory, or via a network, such as the Internet, although not illustrated.

In this embodiment, the cut data generating apparatus 1 (control circuit 5) executes the cut data generating program to execute various processes as the cut data generating apparatus that generates the cut data. Typically, the cut data is generated by generating the cut data for cutting along the outline L0 that represents the pattern, from data on the outline L0. At this time, the user is allowed to issue an instruction of executing the hand-torn cut data generating process through the operation of the keyboard 3 or the mouse 4. Accordingly, the control circuit 5 functions as an outline identifying unit, a first cutting line forming unit, and a cut data generating unit.

As the processes of generating the hand-torn cut data by the control circuit 5, an outline identifying step of identifying the outline L0 of the pattern, a first cutting line forming step of forming the first cutting line L1 that has a jagged shape swinging with the random swinging amounts in the direction intersecting with the outline L0 along the outline L0, and a cut data generating step of generating the cut data for cutting along the first cutting line L1 are sequentially executed. Consequently, also according to the fifth embodiment, an excellent effect capable of generating the cut data that is for cutting the pattern having the predetermined shape out of the target workpiece W and is capable of cutting with the hand-torn feature, is exerted.

Each embodiment described above has the configuration that randomly determines the value of the swinging amount t. However, the configuration is not limited thereto. That is, multiple values predetermined so as not to exceed the maximum value tₘₐₓ may be assigned to the swinging amount t. In this case, these values may be assigned to the configuration points P in a predetermined order. A single value that does not exceed the maximum value tₘₐₓ may be assigned to the value of the swinging amount t.

In each embodiment described above, the cut data generating apparatus is made up of the cutting apparatus, or a general personal computer. Alternatively, the cut data generating apparatus may be configured as an apparatus dedicated to cut data generation. A configuration may be adopted where the cut data generating apparatus is provided with a scanner that reads data on a graphical item from an original diagram. Alternatively, the present disclosure is not limited to each embodiment described above. The specific configuration of the cutting apparatus can be variously changed. Appropriate changes may be applied in a range without departing from the spirit of the present disclosure.

In the embodiments described above, a single CPU may perform all of the processes. Nevertheless, the disclosure may not be limited to the specific embodiment thereof, and a plurality of CPUs, a special application specific integrated circuit (“ASIC”), or a combination of a CPU and an ASIC may be used to perform the processes.

The foregoing description and drawings are merely illustrative of the principles of the disclosure and are not to be construed in a limited sense. Various changes and modifications will become apparent to those of ordinary skill in the art. All such changes and modifications are seen to fall within the scope of the disclosure as defined by the appended claims.

We claim:

1. A cut data generating apparatus for generating cut data for allowing a cutting apparatus including a cutting mechanism to cut a pattern out of a target workpiece, the cut data generating apparatus comprising a controller,
the controller being configured to control the cut data generating apparatus to:
identify an outline of the pattern;
form a first cutting line that has a jagged shape swinging with a predetermined swinging amount in a direction intersecting with the outline, along the outline; and
generate the cut data for cutting along the first cutting line.

2. The cut data generating apparatus according to claim 1,
the controller being configured to further control the cut data generating apparatus to:
form the first cutting line that has a jagged shape swinging with a random swinging amount in the direction intersecting with the outline, along the outline.

3. The cut data generating apparatus according to claim 1,
the controller being configured to further control the cut data generating apparatus to:
judge whether segments of the first cutting line are in proximity to each other with a distance less than a predetermined distance or intersect with each other;
form a second cutting line where a proximity or intersecting portion between segments of the first cutting line are separated by the predetermined distance or more when judging that the segments of the first cutting line are in proximity to each other with a distance less than the predetermined distance or intersect with each other; and
generate cut data for cutting along the second cutting line.

4. The cut data generating apparatus according to claim 3,
the controller being configured to further control the cut data generating apparatus to:
judge whether a portion between segments of the first cutting line is in the pattern in a case where the segments of the first cutting line are in proximity with each other by a distance less than the predetermined distance; and
form the second cutting line, on a condition where the portion is judged to be in the pattern.

5. The cut data generating apparatus according to claim 3,
the controller being configured to further control the cut data generating apparatus to:
form the second cutting line by changing the swinging amount in a case where the first cutting line is formed.

6. The cut data generating apparatus according to claim 3,
the controller being configured to further control the cut data generating apparatus to:
form the second cutting line by changing a swinging direction to opposite direction in a case where the first cutting line is formed.

7. The cut data generating apparatus according to claim 3,
the controller being configured to further control the cut data generating apparatus to:
change the predetermined distance so as to increase the predetermined distance with increase in a size of the pattern, according to the size of the pattern.

8. The cut data generating apparatus according to claim 3,
the controller being configured to further control the cut data generating apparatus to:
issue a notification when judging that the segments of the first cutting line are in proximity to each other with a distance less than the predetermined distance or intersect with each other.

9. The cut data generating apparatus according to claim 1,
the controller being configured to further control the cut data generating apparatus to:
extract a portion where segments of the outline are in proximity to each other with a distance less than a predetermined distance; and
form the first cutting line so that segments of the first cutting line are separated from each other by at least the predetermined distance at the portion in proximity when the portion where the segments of the outline are in proximity to each other with the distance less than the predetermined distance is extracted.

10. The cut data generating apparatus according to claim 1,
the controller being configured to further control the cut data generating apparatus to:
determine a virtual outline acquired by adding periodical wave-shaped swell to the outline; and
form the first cutting line by adopting the determined virtual outline as the outline of the pattern and by providing the outline with a jagged shape having a random swinging amount.

11. The cut data generating apparatus according to claim 1,
the controller being configured to further control the cut data generating apparatus to:
dispose configuration points at predetermined intervals on the outline;
determine first configuration points acquired by moving the configuration points from the outline by a random swinging amount; and
form the first cutting line by sequentially connecting the first configuration points.

12. The cut data generating apparatus according to claim 11,
the controller being configured to further control the cut data generating apparatus to:
set the predetermined interval.

13. The cut data generating apparatus according to claim 1,
the controller being configured to further control the cut data generating apparatus to:
set a maximum value of the swinging amount.

14. The cut data generating apparatus according to claim 1,
the controller being configured to further control the cut data generating apparatus to:
specify formation of the first cutting line for a part of the outline of the pattern.

15. The cut data generating apparatus according to claim 1,
further comprising a display unit;
the controller being configured to further control the cut data generating apparatus to:
display the formed first cutting line on the display unit.

16. A cut data generating method for generating cut data for allowing a cutting apparatus including a cutting mechanism to cut a pattern of a target workpiece, the cut data generating method comprising:
identifying an outline of the pattern;
forming a first cutting line that has a jagged shape swinging with a random swinging amount in a direction intersecting with the outline, along the outline; and
generating the cut data for cutting along the first cutting line.

17. A non-transitory recording medium configured to store a cutting data generating program, the cutting data generating program including instructions for a computer which has a controller,
the instructions cause, when executed by the controller, the computer to:
identify an outline of a pattern;
form a first cutting line that has a jagged shape swinging with a predetermined swinging amount in a direction intersecting with the outline, along the outline; and
generate cut data for cutting along the first cutting line.
